(19) United States
(12) Patent Application Publication
(10) Pub. No.: US 2020/0288314 A1
(43) Pub. Date: Sep. 10, 2020

(54) Method and Apparatus for Verifying Maintenance of Authentication with AP

(71) Applicant: Dialog Semiconductor Korea Inc., Gyeonggi-do (KR)

(72) Inventor: Hee Jun Kim, Yongin-si (KR)

(21) Appl. No.: 16/802,847

(22) Filed: Feb. 27, 2020

(30) Foreign Application Priority Data
Mar. 4, 2019 (KR) 1020190024754

(51) Int. Cl. H04W 12/06; H04W 4/06; H04W 84/18; H04W 76/19; H04L 1/18; H04W 52/02

(52) U.S. Cl. CPC H04W 12/06; H04W 4/06; H04W 52/0219; H04W 76/19; H04L 1/1887; H04W 84/18

(57) ABSTRACT

A method and an apparatus for verifying maintenance of authentication in a terminal supporting a low power mode is provided. The method includes transmitting a broadcast packet or a multicast packet within a Basic Service Set Identifier (BSSID) and then, receiving retransmission packet from a wireless network apparatus with respect to the respective packets, verifying whether authentication is maintained, and thereby verifying deauthentication with the wireless network apparatus in a shortest time. Through this present disclosure, the efficiency of the wireless communication service can be maximized.

### CROSS-REFERENCE TO RELATED APPLICATIONS

This application claims priority to Korean Patent Application No. 10-2019-0024754, filed on Mar. 4, 2019, which application is hereby incorporated herein by reference.

### TECHNICAL FIELD

The present disclosure in some embodiments relates to a method and an apparatus for verifying maintenance of authentication with an access point (AP). More particularly, the disclosure relates to a method and an apparatus for verifying continuance of authentication with an AP when operating in a low power mode in a Wi-Fi wireless communication environment.

### BACKGROUND

The statements in this section merely provide background information related to the present disclosure and do not necessarily constitute prior art.

In general, in a Wi-Fi wireless communication environment, a station includes a communication period of several seconds between itself and an AP, and authentication with the AP is not released in a communication period of several seconds. Meanwhile, the station is operated in a low power mode, includes a communication period of several minutes between itself and the AP for low power, and in this case, in a communication system set to an encryption mode, a wakeup operation does not occur within an update time range of a security key, and authentication with the AP may be released.

In some cases, for an AP violating the IEEE802.11 standard, a packet indicating that the authentication is released (e.g., DEAUTH) is sent only once, or it may not be sent at all. In this situation, there is a problem that it takes a long time in several minutes until it is recognized that the authentication between the station and the AP has been released.

### SUMMARY

Accordingly, in such a situation, a new technology to verify a case where authentication between a station and an AP is released in a shortest time, and thereby maximize the efficiency of the wireless communication service is required.

An aspect of the disclosure is to provide a terminal supporting a low power mode, which transmits a broadcast packet or a multicast packet within a Basic Service Set Identifier (BSSID) and then, receives a retransmission packet from a wireless network apparatus with respect to the respective packets, verifies whether authentication is maintained, and thereby verifies deauthentication with the wireless network apparatus in a shortest time. Through this present disclosure, the efficiency of the wireless communication service can be maximized.

In accordance with at least one embodiment, the present disclosure provides a terminal. The terminal includes a communication unit configured to transmit, to a wireless network apparatus, an authentication verification packet for verifying whether authentication with the wireless network apparatus is released, a reception verification unit configured to verify whether a retransmission packet which is sent in response to the authentication verification packet from the wireless network apparatus is received, and a controller configured to determine whether the authentication with the wireless network apparatus is released based on whether the retransmission packet is received or not, and perform a procedure of reconnection with the wireless network apparatus based on a result of the determination.

In accordance with another aspect of the disclosure, a method for verifying maintenance of authentication of a terminal is provided. The method includes transmitting an authentication verification packet for verifying whether authentication with a wireless network apparatus is released, verifying whether a retransmission packet which is sent in response to the authentication verification packet from the wireless network apparatus is received, and determining whether the authentication with the wireless network apparatus is released based on whether the retransmission packet is received or not, and performing a procedure of reconnection with the wireless network apparatus based on a result of the determination.

An aspect of the disclosure is to provide a terminal supporting a low power mode, which sends a broadcast packet or a multicast packet within a Basic Service Set Identifier (BSSID) and then, receives a retransmission packet from a wireless network apparatus with respect to the respective packets, verifies whether authentication is maintained, and thereby verifies deauthentication with the wireless network apparatus in a shortest time. Through this present disclosure, the efficiency of the wireless communication service can be maximized.

### BRIEF DESCRIPTION OF DRAWINGS

FIG. 1 is a diagram illustrating a wireless network system, according to an embodiment of the disclosure;

FIG. 2 is a block diagram of a brief configuration of a terminal, according to an embodiment of the disclosure;

FIG. 3 is a flowchart provided to explain a method for verifying maintenance of authentication of a terminal, according to an embodiment of the disclosure;

FIGS. 4A, 4B, and 4C are diagrams of an example process of reconnection with an access point (AP) by a method for verifying maintenance of authentication, according to an embodiment of the disclosure;

FIGS. 5A and 5B are diagrams provided to explain an example retransmission packet transmitting process according to a method for verifying maintenance of authentication, according to an embodiment of the disclosure;

FIGS. 6A, 6B, 7A, and 7B are diagrams provided to explain an example packet sent between a terminal and a wireless network apparatus, according to an embodiment of the disclosure; and

FIG. 8 is a diagram provided to explain an example process of reconnection with an access point (AP) by a method for verifying maintenance of authentication, according to another embodiment of the disclosure.

### DESCRIPTION

Hereinafter, at least one embodiment of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

Additionally, various terms such as first, second, i), ii), a), b), etc., are used solely for the purpose of differentiating one component from the other, not to imply or suggest the substances, the order or sequence of the components. Throughout this specification, when a part “includes” or “comprises” a component, the part is meant to further include other components, not excluding thereof unless specifically stated to the contrary. The terms such as “unit,” “module,” and the like refer to one or more units for processing at least one function or operation, which may be implemented by hardware, software, or a combination particular.

The detailed description, which will be given below with reference to the accompanying drawings, is intended to explain exemplary embodiments of the present disclosure and is not intended to represent the only embodiments in which the present disclosure may be practiced.

In an embodiment of the disclosure, a method for verifying maintenance of authentication with a wireless network apparatus by a terminal supporting a low power mode is described. More particularly, a method for verifying maintenance of authentication is provided to verify deauthentication with a wireless network apparatus in a shortest time and thereby maximize the efficiency of the wireless communication service. To this end, a new kind of authentication maintenance verification method utilizing a broadcast packet or a multicast packet as an authentication verification packet is proposed.

FIG. 1 is a diagram illustrating a wireless network system, according to an embodiment of the disclosure.

A wireless network system according to an embodiment of the disclosure may include a wireless network apparatus 110 and a terminal 120. Herein, it is described that the wireless network system only includes the wireless network apparatus 110 and the terminal 120, but the example is not limited thereto.

The wireless network apparatus 110 is an apparatus which enables the terminal 120 connected to the wireless network apparatus 110 to use Internet connections through a Network Address Translation (NAT) function. That is, the wireless network apparatus 110 may convert a cable Internet signal provided from an Internet Service Provider (ISP) and output the converted cable Internet signal, and thereby realize a wireless network environment. Meanwhile, the wireless network apparatus 110 according to an embodiment of the disclosure may provide a wireless network (Internet) based on IEEE 802.11, that is, a communication standard used in a wireless Local Area Network (LAN) which is commonly referred to as wireless LAN and Wi-Fi. However, the example is not limited thereto. Meanwhile, the terminal 120 may be connected to the wireless network apparatus 110 and access a wireless network, and wirelessly transceive data using the accessed wireless network.

The wireless network apparatus 110 may, when a data link with the terminal 120 is established, perform communication with the terminal 120 at predetermined periods (e.g., in units of several seconds). This refers to a process of verifying whether a data link between the wireless network apparatus 110 and the terminal 120 is properly operated or exchanging messages with each other to prevent disconnection of this data link.

Meanwhile, the wireless network apparatus 110 may, when the terminal 120 is operated in a low power mode, perform communication with the terminal 120 at longer periods (e.g., several minutes) than before. In this case, the wireless network apparatus 110 according to an embodiment of the disclosure may receive, from the terminal 120, an authentication verification packet for verifying whether authentication with the wireless network apparatus 110 has been released. Here, it is preferable that the authentication verification packet is at least one packet from among a broadcast packet or a multicast packet, but the example is not limited thereto.

When the wireless network apparatus 110 receives an authentication verification packet from terminal 120, the wireless network apparatus 110 may transmit a retransmission packet corresponding to the authentication verification packet to the terminal 120. For example, in an embodiment of the disclosure, the wireless network apparatus 110 may, preferably, transmit the same packet as the authentication verification packet received from the terminal 120 to the retransmission packet, but the example is not limited thereto.

That is, the wireless network apparatus 110 may retransmit, to the terminal 120, the same packet as at least one packet from among a broadcast packet or multicast packet received from the terminal 120. In this case, the wireless network apparatus 110 may retransmit the retransmission packet to all stations within the wireless network system, for example, another terminal on the same network maintaining a data link with the wireless network apparatus 110.

The terminal 120 refers to a terminal which is capable of transceiving various data via a network, etc. according to a key manipulation of a user, which may be any one of a tablet PC, a laptop, a personal computer (PC), a smartphone, a personal digital assistant (PDA) and a mobile communication terminal.

The terminal 120 may, as in a case where a data link with the wireless network apparatus 110 is established, verify whether the data link is properly operated, or perform communication at predetermined periods (e.g., in units of several seconds) with the wireless network apparatus 110 in order to prevent release of this data link.

The terminal 120 according to an embodiment may support a low power mode. The low power mode denotes a mode in which a power saving environment is provided with the restriction of some functions affecting battery consumption from among a plurality of functions provided by the terminal 120.

When no data is transceived for a predetermined period of time through a data link established with the wireless network apparatus 110, the terminal 120 may be operated in a low power mode. Meanwhile, the terminal 120 may, when operated in a low power mode, perform communication with the wireless network apparatus 110 at longer periods (e.g., in units of several minutes) than before.

The terminal 120 according to an embodiment of the disclosure may, when operated in a low power mode, transmit an authentication verification packet for verifying whether authentication with the wireless network apparatus 110 is released. In this case, the terminal 120 may temporarily switch its mode from the low power mode to an active mode at every communication period, and transmit the authentication verification packet.

Thereafter, the terminal 120 may monitor whether a retransmit packet sent in response to the authentication verification packet from the wireless network apparatus 110 is received. In another embodiment, the terminal 120 may monitor whether a retransmission packet sent in response to an authentication verification packet received from other terminal other than the terminal 120 by the wireless network apparatus 110 is received from the wireless network apparatus 110. Here, the other terminal may be all stations within the wireless network system, for example, another terminal on the same network maintaining a data link with the wireless network apparatus 110.

The terminal 120 may, when the retransmission packet is normally received from the wireless network apparatus 110 upon monitoring, regard that authentication with the wireless network apparatus 110 is maintained.

In contrast, the terminal 120 may, when it is verified that the retransmission packet is abnormally received from the wireless network apparatus 110 upon monitoring, regard that authentication with the wireless network apparatus 110 is released. Thereafter, the terminal 120 may perform a rescan process with respect to an accessible wireless network apparatus.

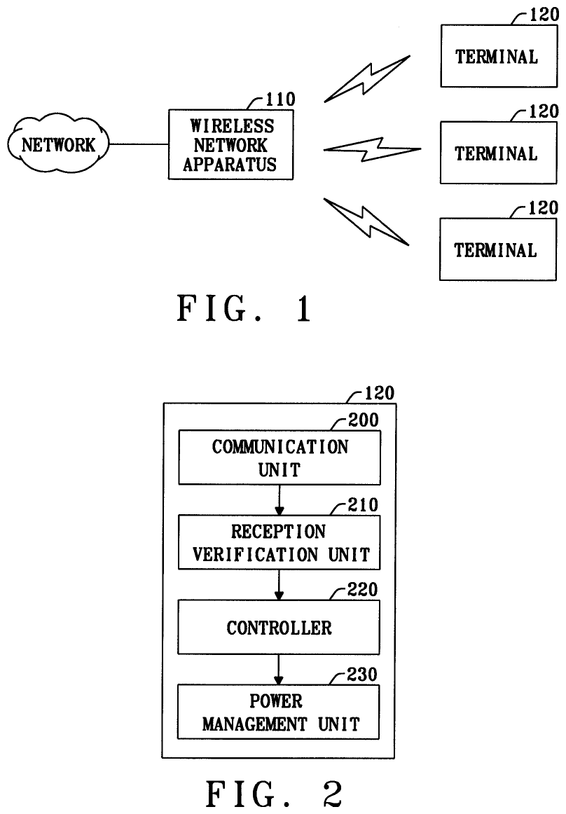

FIG. 2 is a block diagram of a brief configuration of a terminal, according to an embodiment of the disclosure.

The terminal 120 according to an embodiment of the disclosure may include a communication unit 200, a reception verification unit 210, a controller 220 and a power management unit 230. Here, the elements of the terminal 120 are not necessarily limited thereto.

The communication unit 200 may function as a communication means for accessing a network so that the terminal 120 may provide at least one service using network resources.

The communication unit 200 according to an embodiment of the disclosure may, when the terminal 120 is operated in a low power mode, transceive an authentication verification packet for verifying whether authentication with the wireless network apparatus 110 is released, and a retransmission packet corresponding to the authentication verification packet.

In an embodiment of the disclosure, the communication unit 200 may transmit at least one packet from among a broadcast packet and a multicast packet to the wireless network apparatus 110 as the authentication verification packet.

The communication unit 200 may receive the same packet as the authentication verification packet described above, from the wireless network apparatus 110 as a retransmission packet. In another embodiment, the communication unit 200 may receive a retransmission packet sent in response to an authentication verification packet received from a terminal other than the terminal 120 by the wireless network apparatus 110.

The reception verification unit 210 may verify whether a retransmission packet which is sent in response to the authentication verification packet from the wireless network apparatus 110 is received.

In an embodiment of the disclosure, the reception verification unit 210 may verify whether the same packet as the authentication verification packet is received from the wireless network apparatus 110 as a retransmission packet. That is, the reception verification unit 210 may verify whether the same packet as at least one packet from among the broadcast packet and multicast packet sent via the communication unit 200 is resent from the wireless network apparatus 110.

In another embodiment, the reception verification unit 210 may verify whether a retransmission packet sent in response to an authentication verification packet received from other terminal is received from the wireless network apparatus 110. Here, the other terminal may be any one terminal from among terminals on the same network maintaining a data link with the wireless network apparatus.

The controller 220 may determine whether authentication with the wireless network apparatus 110 is released based on verification through the reception verification unit 210 of whether the retransmission packet is received, and perform a process of reconnection with the wireless network apparatus 110.

The controller 220 may, when the retransmission packet is normally received from the wireless network apparatus 110 based on the determination, regard that authentication with the wireless network apparatus 110 is maintained.

The controller 220 may, when it is verified that the retransmission packet is abnormally received from the wireless network apparatus 110 based on the determination, regard that authentication with the wireless network apparatus 110 is released. In this case, the controller 220 may perform a rescan process with respect to an accessible wireless network apparatus.

The power management unit 230 may perform a function of controlling an operation of the terminal 120 to either a low power mode or an active mode.

The power management unit 230 according to an embodiment of the disclosure may switch the terminal 120 from the low power mode to the active mode at every preset transmission period of an authentication verification packet. In this case, preferably, the preset transmission period of the authentication verification packet is a communication period in the low power mode, but is not limited thereto.

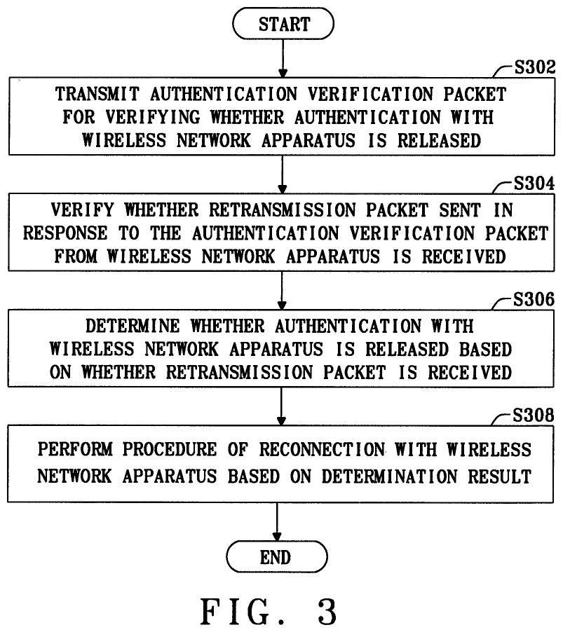

FIG. 3 is a flowchart provided to explain a method for verify maintenance of authentication of a terminal, according to an embodiment of the disclosure.

The terminal 120 may, when operated in a low power mode, transmit an authentication verification packet for verifying whether authentication with the wireless network apparatus 110 is released (S302). At operation S302, the terminal 120 may transmit at least one packet from among a broadcast packet and a multicast packet to the wireless network apparatus 110 as the authentication verification packet.

The terminal 120 may verify whether a retransmission packet sent in response to the authentication verification packet of the operation S302 from the wireless network apparatus 110 is received (S304). At operation S304, the terminal 120 may verify whether the same packet as the authentication verification packet of the operation S302 is received as a retransmission packet.

In another embodiment, the terminal 120 may verify whether a retransmission packet sent in response to an authentication verification packet received from another terminal is received from the wireless network apparatus 110.

The terminal 120 may determine whether authentication with the wireless network apparatus 110 is released based on the verification of the operation S304 (S306), and according to the determination result of the operation S306, adaptively perform a process of reconnection with the wireless network apparatus 110 (S308). At operation S306, the terminal 120 may, when it is verified that the retransmission packet is abnormally received from the wireless network apparatus 110 based on the verification result of the operation S304, regard that authentication with the wireless network apparatus 110 is released.

The operations S302, S304, S306, and S308 respectively correspond to operations of the elements of the terminal 120 described above and thus, the description thereof will be omitted herein.

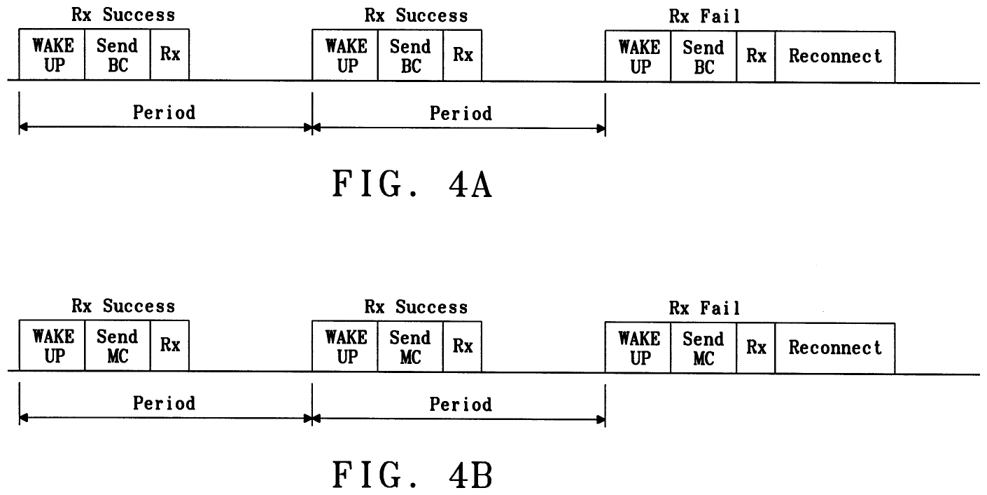

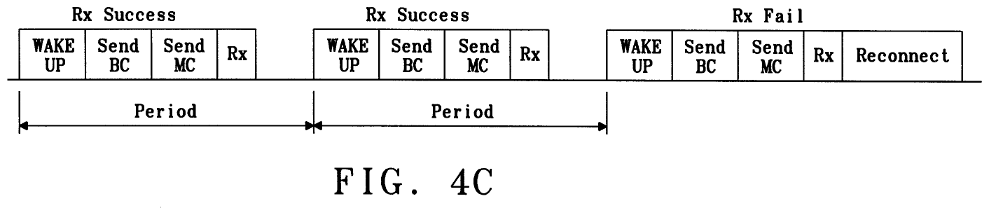

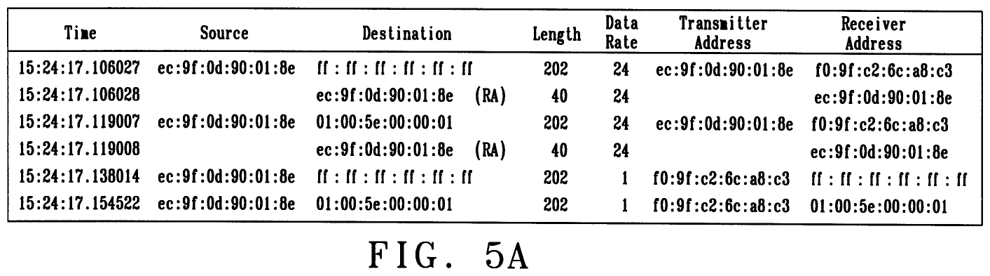

FIGS. 4A, 4B, and 4C are diagrams of an example process of reconnection with an access point (AP) by a method for verifying maintenance of authentication, according to an embodiment of the disclosure.

Referring to FIG. 4A, the terminal 120 may perform wakeup after a sleep mode for several minutes.

The terminal 120 may, in order to verify maintenance of authentication with the wireless network apparatus 110, transmit a broadcast packet within a Basic Service Set Identifier (BSSID), and verify whether a retransmission packet is received from the wireless network apparatus 110 for a predetermined time.

The terminal 120 may, when maintenance of authentication with the wireless network apparatus 110 is verified according to whether a retransmission packet is received, and then the authentication is released, perform reconnection with the wireless network apparatus 110.

Referring to FIG. 4B, in another embodiment, the terminal 120 may perform the same process as in FIG. 4A, but transmit a multicast packet within the BSSID as an authentication verification packet to verify maintenance of authentication with the wireless network apparatus 110.

Referring to FIG. 4C, in another embodiment, the terminal 120 may perform the same process as in FIG. 4A, and transmit a broadcast packet and multicast packet within the BSSID as an authentication verification packet to verify verification with the wireless network apparatus 110. In this case, the terminal 120 may, for a predetermined time after transmitting the authentication verification packet, verify a retransmission packet of any one of the broadcast packet or the multicast packet is received from the wireless network apparatus 110.

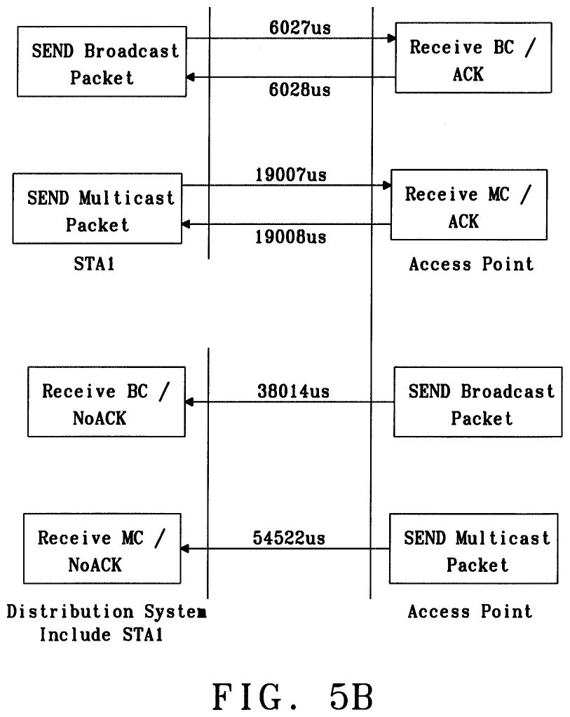

FIGS. 5A and 5B are diagrams provided to explain an example retransmission packet transmitting process according to a method for verifying maintenance of authentication, according to an embodiment of the disclosure.

FIG. 5A is a diagram capturing in an actual environment a process in which the terminal 120 performs wakeup in a low power mode and then, to verify maintenance of authentication with the wireless network apparatus 110, transmits each of a broadcast packet and a multicast packet to the wireless network apparatus 110, and the respective packets are resent from the wireless network apparatus after approximately 32 ms.

FIG. 5B is a diagram schematically illustrating a process of FIG. 5A.

Referring to FIG. 5A, the terminal 120 may transmit a broadcast packet to the wireless network apparatus 110 at a time 15:24:17.106027.

Ata time 15:24:17.106028, the wireless network apparatus 110 may transmit a response to the reception to the terminal 120 as an acknowledgement (ACK) packet.

Ata time 15:24:17.119007, the terminal 120 may transmit a multicast packet to the wireless network apparatus 110.

At a time 15:24:17.119008, the wireless network apparatus 110 may transmit a response to the reception to the terminal 120 as an acknowledgement packet.

Ata time 15:24:17.138014, the wireless network apparatus 110 may retransmit the received broadcast packet to all terminals within the wireless network system. In this case, the terminal may not transmit an acknowledgement packet to the wireless network apparatus 110.

At a time 15:24:17.138022, the wireless network apparatus 110 may retransmit the received multicast packet to all terminals within the wireless network system. In this case, the terminal may not transmit an acknowledgement packet to the wireless network apparatus 110.

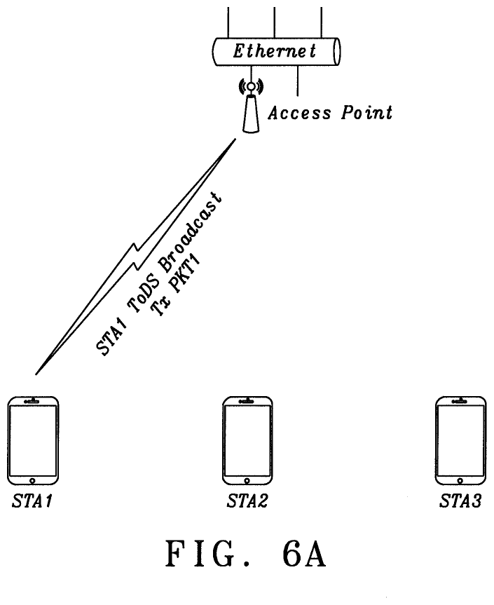

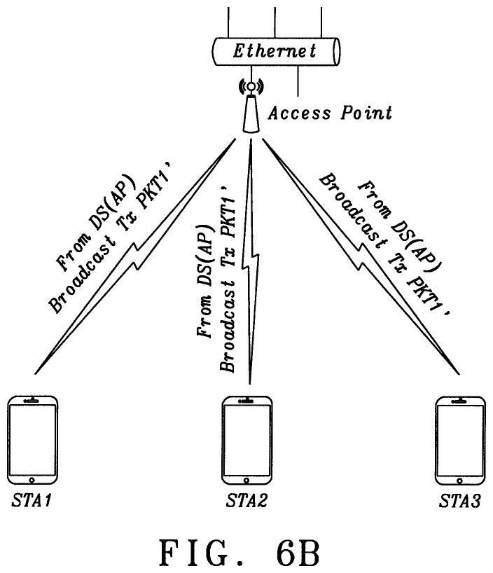

FIGS. 6A and 6B are diagrams exemplifying a case where a broadcast packet is sent between a terminal and a wireless network apparatus as an authentication verification packet, according to an embodiment of the disclosure.

Referring to FIG. 6A, it can be understood that a terminal (e.g., STA1) transmits a broadcast packet to the wireless network apparatus 110 to verify whether authentication has been released. In this case, the other terminals (e.g., STA2 and STA3) also physically receive the packet because they are in the same frequency propagation environment, but the packet is discarded because the receive address is not their own address.

Referring to FIG. 6B, it can be understood that the wireless network apparatus 110 retransmits a broadcast packet to terminals (e.g., STA1, STA2 and STA3) within the wireless network system. In this case, the terminals within the wireless network system may receive the packets when the receiver address is a broadcast address.

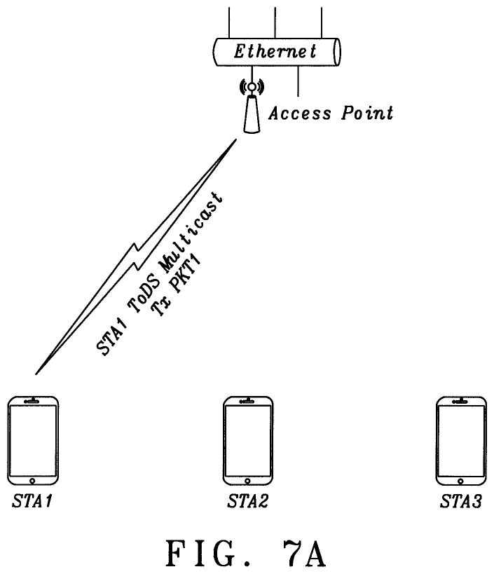

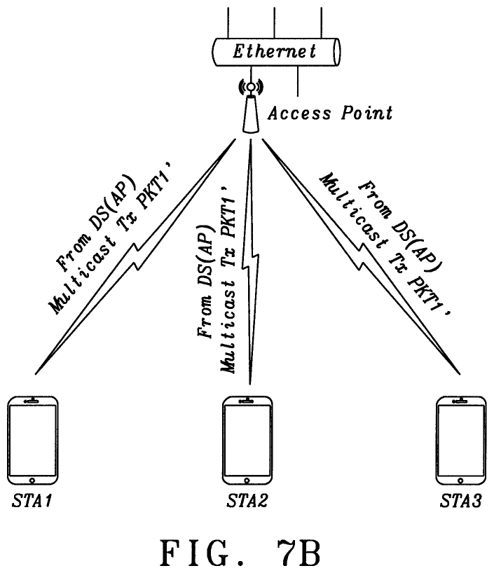

FIGS. 7A and 7B are diagrams exemplifying a case where a multicast packet is sent between a terminal and a wireless network apparatus as an authentication verification packet, according to an embodiment of the disclosure.

Referring to FIG. 7A, it can be understood that a terminal (e.g., STA1) transmits a multicast packet to the wireless network apparatus 110 to verify whether authentication has been released. In this case, the other terminals (e.g., STA2 and STA3) also physically receive the packet because they are in the same frequency propagation environment, but the packet is discarded because the receive address is not their own address.

Referring to FIG. 7B, it can be understood that the wireless network apparatus 110 retransmits a multicast packet to terminals (e.g., STA1, STA2 and STA3) within the wireless network system. In this case, the terminals within the wireless network system may receive the packets when the receiver address is a multicast address.

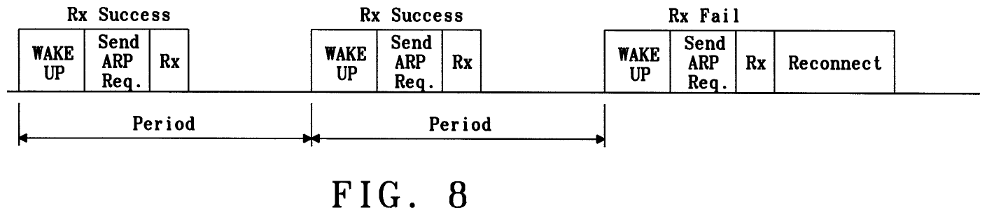

FIG. 8 is a diagram provided to explain an example process of reconnection with an access point (AP) by a method for verifying maintenance of authentication, according to another embodiment of the disclosure. Meanwhile, a method for verifying maintenance of authentication according to another embodiment of the disclosure is an example in a case where an Address Resolution Protocol (ARP) request packet is used as an authentication verification packet for verifying whether authentication with the network apparatus 110 is released. This method for verifying maintenance of authentication according to another embodiment of the disclosure may be performed through each of elements of the terminal 120 illustrated in FIG. 2.

Meanwhile, the ARP request packet may be basically used as broadcast and unicast. However, an example in which the ARP request packet is used as unicast will be described herein. Accordingly, unlike the broadcast or multicast packet (1:n) previously used as an authentication verification packet, one-to-one (1:1) communication with the wireless network apparatus 110 may be performed.

Referring to FIG. 8, the terminal 120 may perform wakeup after a sleep mode for several minutes.

To verify maintenance of authentication with the wireless network apparatus 110, the terminal 120 may transmit an ARP request packet to the wireless network apparatus 110. In this case, the terminal 120 may set a destination IP of the ARP request packet as an IP of the wireless network apparatus 110, and transmit the ARP request packet.

The terminal 120 may await reception of an ARP response packet from the wireless network apparatus 110 for a predetermined time after transmitting the ARP request packet.

The terminal 120 may, when maintenance of authentication with the wireless network apparatus 110 is verified according to whether an ARP response packet is received, and then the authentication is released, perform reconnection with the wireless network apparatus 110.

Although the steps in the respective flowcharts are described to be sequentially performed, they merely instantiate the technical idea of some embodiments of the present disclosure. Therefore, a person having ordinary skill in the pertinent art could perform the steps by changing the sequences described in the respective drawings or by performing two or more of the steps in parallel, and hence the steps in the respective flowcharts are not limited to the illustrated chronological sequences.

Various implementations of the systems and methods described herein, including the communication unit, wireless network apparatus, reception verification unit, controller, and the power management unit, previously describe, may be realized through digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions to and from a storage system, at least one input device, and at least one output device, wherein the programmable processor may be a special-purpose processor or a general-purpose processor. Computer programs (which are also known as programs, software, software applications or code) contain instructions for a programmable processor and are stored in a “computer-readable recording medium.”

The computer-readable recording medium refers to any computer program product, apparatus, and/or device (e.g., non-volatile or non-transitory recording medium such as CD-ROM, ROM, memory card, hard disk, an optical/magnetic disk, storage devices, and the like) used to provide instructions and/or data to a programmable processor.

Various implementations of the systems and techniques described herein can be realized by a programmable computer. Here, the computer includes a programmable processor, a data storage system (including volatile memory, nonvolatile memory, or any other type of storage system or a combination thereof) and at least one communication interface. For example, the programmable computer may be one of a server, a network device, a set-top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the various characteristics of the disclosure. Therefore, exemplary embodiments of the present disclosure have been described for the sake of brevity and clarity. Accordingly, one of ordinary skill would understand the scope of the disclosure is not limited by the above explicitly described embodiments but by the claims and equivalents thereof.

What is claimed is:

1. A terminal, comprising:
a communication unit configured to transmit, to a wireless network apparatus, an authentication verification packet for verifying whether authentication with the wireless network apparatus is released;
a reception verification unit configured to verify whether a retransmission packet which is sent in response to the authentication verification packet from the wireless network apparatus is received; and
a controller configured to determine whether the authentication with the wireless network apparatus is released based on whether the retransmission packet is received or not, and perform a procedure of reconnection with the wireless network apparatus based on a result of the determination.

2. The terminal as claimed in claim 1, further comprising:
a power management unit configured to control an operation of the terminal to either a low power mode or an active mode, and
wherein the power management unit switches the terminal from the low power mode to the active mode at every preset transmission period of the authentication verification packet.

3. The terminal as claimed in claim 1, wherein the communication unit transmits at least one of a broadcast packet and a multicast packet as the authentication verification packet.

4. The terminal as claimed in claim 1, wherein the reception verification unit verifies whether a same packet as the authentication verification packet is received from the wireless network apparatus as the retransmission packet.

5. The terminal as claimed in claim 1, wherein the reception verification unit verifies whether the retransmission packet which is sent in response to the authentication verification packet received from another terminal by the wireless network apparatus is received from the wireless network apparatus.

6. The terminal as claimed in claim 5, wherein the another terminal is any one terminal from among terminals on a same network maintaining a data link with the wireless network apparatus.

7. A method for verifying maintenance of authentication of a terminal, the method comprising:
transmitting an authentication verification packet for verifying whether authentication with a wireless network apparatus is released;
verifying whether a retransmission packet which is sent in response to the authentication verification packet from the wireless network apparatus is received; and
determining whether the authentication with the wireless network apparatus is released based on whether the retransmission packet is received or not, and performing a procedure of reconnection with the wireless network apparatus based on a result of the determination.

8. The method for verifying maintenance of authentication of a terminal as claimed in claim 7, wherein in the transmitting, at least one of a broadcast packet and a multicast packet is sent as the authentication verification packet.

9. The method for verifying maintenance of authentication of a terminal as claimed in claim 7, wherein in the verifying, whether a same packet as the authentication verification packet is received from the wireless network apparatus as the retransmission packet is verified.
